(19) United States
(12) Patent Application Publication
(10) Pub. No.: US 2007/0148529 A1
(43) Pub. Date: Jun. 28, 2007

(54) Cathode material for a high-temperature fuel cell (sofc) and a cathode that can be produced therefrom

(75) Inventors: Hans Peter Buchkremer, Heinsberg (DE); Frank Tietz, Julich (DE); Andreas Mai, Koln (DE); Detlev Stover, Niederzier (DE)

Correspondence Address: THE FIRM OF KARL F ROSS, 5676 RIVERDALE AVENUE, PO BOX 900, RIVERDALE (BRONX), NY, 10471-0900, US

(73) Assignee: FORSCHUNGSZENTRUM JULICH GMBH, Julich (DE)

(21) Appl. No.: 10/578,297

(22) PCT Filed: Nov. 4, 2004
(86) PCT No.: PCT/DE04/02443

§ 371 Date: Feb. 5, 2007

(30) Foreign Application Priority Data
Nov. 7, 2003 (DE) 103 51 955.6

(51) Int. Cl. H01M 4/90; H01M 4/88; C01G 49/02

(52) U.S. Cl. 429/40; 502/101; 423/594.2

(57) ABSTRACT

The invention relates to a cathode material, particularly for use in a high-temperature fuel cell, comprising substoichiometric Ln_{1-x-y}M_{y}Fe_{1-z}C_{z}O_{3-δ}, with 0.02≦×x≦0.05, 0.1≦y≦0.6, 0.1≦z≦0.3, 0≦δ≦0.25 and with Ln=lanthanides, M=strontium or calcium and C=cobalt or copper. By using a particular production method, in which this cathode material having a specified grain size is used, and in which a (Ce, Gd)O_{2-δ}-intermediate layer is advantageously formed between the cathode and electrolyte, a cathode is obtained that, when used in a high-temperature fuel cell, can achieve a power greater than 1 W/cm² already at 750° C. and a cell voltage of 0.7 V.

The invention relates to a cathode material for a fuel cell, especially for a high-temperature fuel cell, as well as a suitable method for preparing a cathode comprising this cathode material.

### PRIOR ART

High-temperature fuel cells (SOFC) have due to the elevated temperatures special demands on the materials used. So it is known for example from DE 195 43 759 C1 to use in a high-temperature fuel cell cermets of nickel and yttrium-stabilized zircon oxide (YSZ) as anode material and YSZ as electrolyte material. The cathode material used in such a high-temperature fuel cell should have due to the high temperatures especially the following characteristics: it should have a thermal expansion coefficient adapted to the surrounding materials to avoid thermally related tensions and destructions associated therewith. The cathode material further should have a chemical compatibility with the adjacent materials as well as a high electrochemical activity. This means that the cathode material should have a good oxygen reduction behavior. Moreover a high electrical conductivity and high ionic conductivity are desirable.

From EP 0 593 281 B1 an electrode material is known consisting of La_{0.8}Ca_{0.2}Mn_{(1-y)}(Al, Co, Mg, Ni)_{y}CO₃1 wherein 0.05≦y≦0.2 applies. This material shows a suitable thermal expansion behavior for high-temperature fuel cells. From literature [1] is further known to use (La, Sr)MnO₃ cathodes with an A-position substoichiometry for increasing the chemical stability and for reducing of a reaction with an YSZ electrolyte.

An improvement of the performance compared to a (La, Sr)MnO₃ cathode is disclosed in [2] where a La_{0.8-x}Sr_{0.2}FeO_{3-δ} cathode is used. However, an A-position substoichiometry in this material is considered as performance reducing.

In EP 568 281 A1 and EP 510 820 A2 electrodes are described that consist of substoichiometric Perowskits. According to EP 568 281 A1 in lanthanum/calcium manganites the ratio (lanthanum+calcium)/manganese should be smaller than 1 to guarantee that no lanthanum hydroxides are formed. In EP 510 820 A2 it is stated that in the Perowskit materials used for electrodes a deficit in calcium, lanthanum or strontium should be present. As materials lanthanum-manganate or lanthanum-cobaltate are mentioned, wherein a part of the calcium can be substituted by strontium.

It can be extracted from the German patent document DE 197 02 619 C1 that an improvement of the electrochemical characteristics can be achieved for example by using cathode materials containing cobalt. A substoichiometric material is described for a cathode with L_{w}MₓMn_{y}Co_{z}O₃ with L=lanthanide, M=Ca or Sr, wherein different to EP 0 593 281 B1 now it is 0.9<(w+x)<1. The substoichiometry of the material shall advantageously effect an increased electrochemical activity due to an improved oxygen reduction behavior.

Further known from literature are (La, Sr)(Co, Fe)oxides as very good materials for a cathode material for high-temperature fuel cells, especially La_{0.6}Sr_{0.4}Co_{0.2}Fe_{0.8}O_{3-δ} is mentioned thereby.

Generally it is difficult to do a comparison of the characteristics of the various cathode materials that are described in the literature since these are used and tested often under different operational conditions. It is desirable to provide a high-temperature fuel cell that can operate efficiently already at temperatures below 800° C. Thereby the cell voltage should not be below 0.7 V and still a possibly high performance for example above 0.8 W/cm², especially above 1 W/cm² should be achieved.

### Object and Solution

It is an object of the invention to provide an improved cathode material for high-temperature fuel cells that has a significant performance improvement compared to the cathode materials know up to now from the state of the art. Further it is object of the invention to provide a method of preparation for a cathode from the above-mentioned cathode material.

These objects of the invention are solved by a cathode material with the entirety of the features according to the main claim. Further the object of the invention is solved by a method of preparation for a cathode as well as by a cathode in the entirety of features according to the additional claims. Advantageous designs of the cathode material, the cathode and the method of preparation can be found in the respectively related claims.

Subject Matter of the Invention

The cathode material according to claims consists of a material with the following general composition: Ln_{1-x-y}M_{y}Fe_{1-z}C_{z}O_{3-δ} with 0.02≦x≦0.05, 0.1≦y≦0.6, 0.1≦z≦0.3, 0≦δ≦0.25 and with Ln=lanthanide, M=strontium or calcium and C=cobalt or copper. An especially success promissory embodiment has thereby the composition La_{0.58}Sr_{0.4}Fe_{0.8}Co_{0.2}O_{3-δ}. In addition to copper especially the cobalt amount in the material effects a good oxygen reduction behavior at the cathode. The copper or cobalt amount can be up to 0.3. Higher amounts generally lead to chemical incompatibilities and to a great thermal expansion coefficient compared to the remaining materials used such as for example an electrolyte consisting of YSZ. The amounts of iron and cobalt or iron and copper complement one another to 1 according to claims.

The components on the A-positions, Ln and N, i.e. lanthanide and strontium or calcium, guarantee the crystallization of the material in the crystal structure of Perowskit. This crystal structure has proved with respect to the material characteristics as suitable for the high-temperature fuel cell. As advantageous was especially the combination of lanthanum and strontium.

In contrast to known standard cathode materials in the material according to invention the occupancy of the A-positions is not stoichiometric. The substoichiometry is thereby between 0.02 and 0.05 so that the amount of for example lanthanum and strontium is however smaller than 1 but regularly greater than 0.95. The positive characteristics of the cathode material are regularly not affected by the exchange of calcium instead of strontium or other lanthanides instead of lanthanum. The cathode according to invention has one of the above-mentioned cathode materials according to invention. Further this material is present in the cathode with an average grain size in the range of 0.4 to 1.0 μm, especially in the range of 0.6 to 0.8 μm. A grain size distribution of 0.8 μm was especially suitable. Preferred cathodes have as cathode materials the compositions La_{0.58}Sr_{0.4}Fe_{0.8}Co_{0.2}O_{3-δ} or La_{0.55}Sr_{0.4}Fe_{0.8}Co_{0.2}O_{3-δ} or also La_{0.78}Sr_{0.2}Fe_{0.8}Co_{0.2}O_{3-δ} without limiting the remaining disclosed compositions. A further advantageous compound that is in the scope of the invention and has a slightly higher cobalt amount is for example La_{0.5}Sr_{0.4}Fe_{0.7}Co_{0.3}O_{3-δ}. In this compound the thermal expansion coefficient is slightly higher, however the electrochemical characteristics are somewhat better than in the above-mentioned compounds. Also especially positive was the copper-containing compound La_{0.58}Sr_{0.4}Fe_{0.8}Cu_{0.2}O_{3-δ}. The material data with respect to the oxygen reduction behavior are especially in the case of this compound very promising.

The above-mentioned advantageous grain size distribution in the cathode is especially possible through a special method of preparation. Thereby the starting material (cathode material) with an average grain size d₅₀ less than 2 μm, especially with a grain size d₅₀ between 0.6 and 0.8 μm is utilized. The d₅₀-value means the median of the grain size distribution, i.e. 50% of the particles (according to number) are smaller or equal the d₅₀-value. With a completed cathode the average grain size distribution can be determined for example through the image analysis of an electron microscopic recording. Also an estimate is possible with an electron microscopic recording. The relatively small grain size of the starting material in connection with the selected cathode material allows advantageously a low sintering temperature that is regularly below 1100° C. Hereby especially the substoichiometry is decisive for the high sintering activity. The low sintering temperature in turn effects on the one hand by the microstructure created thereby the required porosity and on the other hand guarantees advantageously the required stability.

The cathode material according to invention for a high-temperature fuel cell allows due to, its advantageous composition in connection with an optimal method of preparation adapted thereto to create a cathode that in operation at 750° C. and a cell voltage of 0.7 V can reproducibly achieve a performance of more than 1 W/cm².

A suitable method of preparation for a cathode according to invention is for example the one described below. First an anode-electrolyte composite is prepared. Onto that first an intermediate layer with a smaller porosity is applied. Such a layer is for example a (Ce, Gd)O_{2-δ} layer (CGO layer) with 0≦δ≦0.25. This intermediate layer is applied in the form of a powder with an average grain size d₅₀ smaller than 2 μm, especially with a grain size d₅₀ smaller than 0.8 μm. The sintering takes place at temperatures in the range of 1250 and 1350° C. In this way an intermediate layer with a porosity of regularly less than 35%, especially of less than 30% is obtained. The application of the powder of the intermediate layer can be carried out by usual methods such as for example screen processing.

In a subsequent step onto this anode-electrolyte intermediate layer composite the cathode is applied in the form of a powder with an average grain size d₅₀ smaller than 2 μm, especially with a grain size d₅₀ between 0.6 and 0.8 μm. As powder materials all above-mentioned iron- and cobalt- or copper-containing cathode materials with A-position substoichiometry are suitable. These are then sintered at temperatures in the range of 950 to 1150° C., wherein depending on the cathode material a possibly low sintering temperature is chosen. In this way a cathode with a porosity of regularly 20 to 40%, especially of 25 to 35% is obtained. Thereby an average grain size is between 0.4 and 1.0 μm, especially between 0.6 and 0.8 μm. Especially advantageous is an average grain size of 0.8 μm. The application of the powder for the cathode layer can be also carried out by usual methods such as for example screen processing.

Specific Description

In the following the subject matter of the invention is explained in more detail with some figures and design examples without limiting the subject matter of the invention thereby. The cathode material of the cathode according to invention consists of Ln_{1-x-y}M_{y}Fe_{1-z}C_{z}O_{3-δ} with 0.02≦x≦0.05, 0.1≦y≦0.6 and 0.1≦z≦0.3. Thereby is meant Ln=lanthanide, M=strontium or calcium and C=cobalt or copper.

Especially it consists of Perowskits with the composition range La_{0.4-0,75}Sr_{0.3-0.5}Fe_{0.8}Co_{0.2}O_{3-δ} and x=0.02-0.05. As an especially suitable example of design in the following the cathode material with the composition La_{0.58}Sr_{0.4}Fe_{0.8}Co_{0.2}O_{3-δ} is explained.

Problems that can occur due to the chemical incompatibility with the electrolyte material and the high thermal expansion coefficient are thereby regularly avoided as follows:
Using an intermediate layer of Ce_{0.8}Gd_{0.2}O_{2-δ} between cathode and electrolyte. This reduces the mechanical tensions and reduces the formation of SrZrO₃ by spatial separation of the reactants.
Using a cathode-material with an A-position substoichiometry (x>0). Due to the higher sintering activity so sintering temperatures of the cathode are regularly-possible below 1100° C. This prevents on the one hand flaking due to the difference in the thermal expansion coefficient and on the other hand the strontium diffusion through the intermediate layer with SrZrO₃ formation. Hereby the strontium diffusion is additionally cut off by the higher stability of the substoichiometric material compared to the Sr removal. The cobalt-containing and especially the stoichiometric Perowskits are generally chemically not totally stable. The material depletes in the presence of reaction partners—here the YSZ—easily in strontium. This effect is also called Sr removal or strontium depletion.

An especially advantageous method of preparing a high-temperature fuel cell is given in the following. As starting materials are used:
an anode-electrolyte composite such as for example known by DE 195 43 759 C1;
Ce_{0.8}Gd_{0.2}O_{2-δ} powder (CGO) with an average grain size d₅₀<0.8 μm, especially with d₅₀=0.2 μm;
iron- and cobalt- or copper-containing cathode material (e.g. La_{0.58}Sr_{0.4}Fe_{0.8}Co_{0.2}O_{3-δ}) with A-position substoichiometry and with an average grain size d₅₀<2 μm, especially d₅₀ between 0.6 and 0.8 μm.

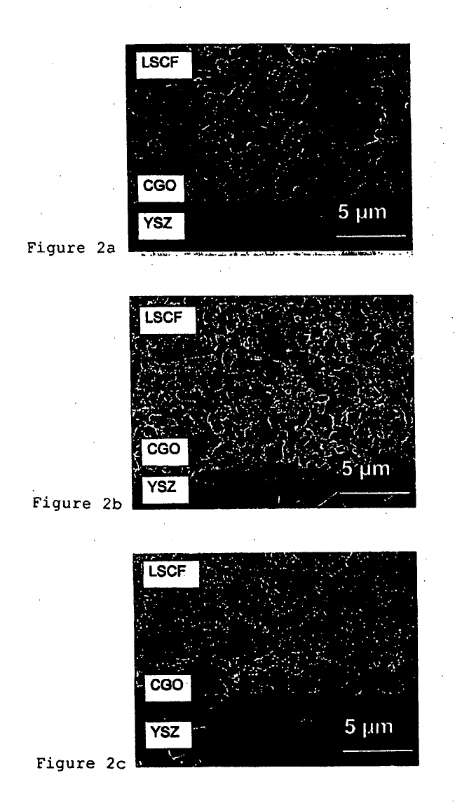

The materials are applied to the anode-electrolyte composite through screen processing or similar methods. The sintering of the two layers, the intermediate layer and the cathode, has then to take place at temperatures that on the one hand are low enough to avoid a reaction with the YSZ electrolyte but on the other hand are high enough to effect a sufficient. sintering of the materials. This temperature is in the sintering of the CGO-layer between 1250 and 1350° C., especially at about 1300° C., in the sintering of the cathode between 950 and 1150° C., especially at about 1080° C. The result is an intermediate layer and a cathode with a micro structure such as for example represented in FIG. 2b. Hereby it is especially important for a high performance density that the porosity of the CGO-layer is possibly low, in all cases below 30%. Further the porosity of the sintered cathode should be between 20 and 40% and have an average grain size between 0.4 and 1.0 μm, especially of 0.8 μm.

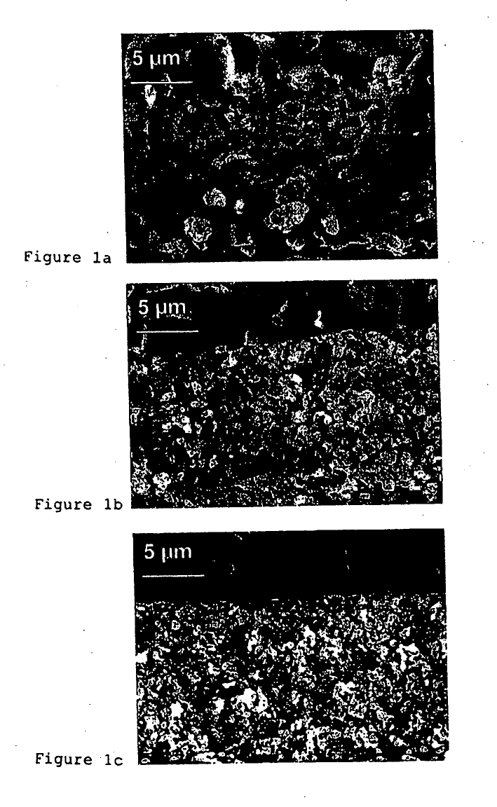

The influence of the sintering temperature on the micro structure of a cathode material can be seen in the FIGS. 1 and 2. In FIG. 1 a commercial (La, Sr)MnO₃ cathode material was utilized and sintered at different temperatures. Then the cathode was places in a high-temperature fuel cell and tested under standard conditions (cathode size 40×40 mm², 750° C., 0.7 V cell voltage, gas streaming parallel to the electrode surfaces).

The parameters for the test are:

FIG. 1a: sintering at 1200° C., performance: 0.26 W/cm²

FIG. 1b: sintering at 1150° C., performance: 0.30 W/cm²

FIG. 1c: sintering at 1100° C., performance: 0.35 W/cm²

It can be seen that with manganese-based cathodes the performance density can be increased by about 30% by lowering the sintering temperature with 100° C.

In FIG. 2 accordingly a cathode material (La_{0.58}Sr_{0.4}Fe_{0.8}Co_{0.2}O_{3-δ}) according to invention was utilized and also sintered at different temperatures and then tested in a high-temperature fuel cell under standard conditions.

The parameters for the test are:

FIG. 2a: sintering at 1120° C., performance: 0.53 W/cm²

FIG. 2b: sintering at 1080° C., performance: 1.01 W/cm²

FIG. 2c: sintering at 1040° C., performance: 0.89 W/cm²

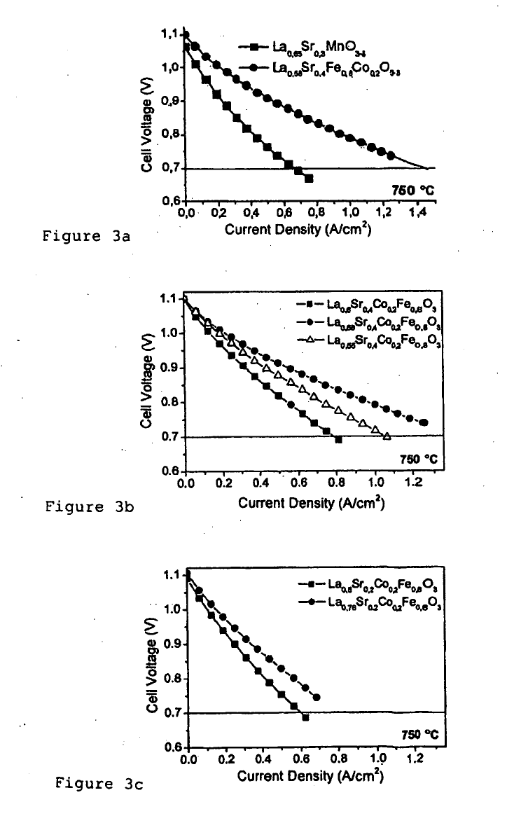

The figures prove that the performance density can be almost increased by factor 2 by lowering the sintering temperature with only 40° C. to 1080° C. This effect does not only result from the improved micro structure. Additionally lower sintering temperatures effect regularly also a lower tendency of forming SrZrO₃ and flaking. The effects of the A-position substoichiometry of the starting material on the performance capability of the cathodes are shown in FIG. 3a to c.

In FIG. 3a the comparison between a commercial manganese-containing (La_{0.65}Sr_{0.3}MnO_{3-δ}) and a cathode material according to invention (La_{0.59}Sr_{0.4}Fe_{0.8}Co_{0.2}O_{3-δ}) is shown. Under standard conditions the fuel cell with the manganese-containing cathode reaches almost 0.7 A/cm², while the cathode according to invention reaches almost more than factor 2. With 0.7 V cell voltage 1.43 A/cm² corresponds to a performance density of about 1 W/cm². This performance density is also clearly higher than that of manganese-based cells of other manufacturers [3].

In FIGS. 3b and 3c fuel cells with cathodes of substoichiometric (La, Sr)(Fe, Co)O₃ and cathodes of stoichiometric cathode material are compared under standard conditions. In FIG. 3b a cathode of stoichiometric La_{0.6}Sr_{0.4}Fe_{0.8}Co_{0.2}O_{3-δ} as cathode material is compared with two cathodes having a 2% (La_{0.58}Sr_{0.4}Fe_{0.8}Co_{0.2}O_{3-δ}) and a 5% (La_{0.55}Sr_{0.4}Fe_{0.8}Co_{0.2}O_{3-δ}) substoichiometry on the A-position. The 5% substoichiometry effects a clear performance increase of more about 35% while the 2% substoichiometry shows even an improvement of more than 70%. In. FIG. 3c a comparison between a stoichiometric (La_{0.8}Sr_{0.2}Fe_{0.8}Co_{0.2}O_{3-δ}) and another substoichiometric cathode according to invention (La_{0.78}Sr_{0.2}Fe_{0.8}Co_{0.2}O_{3-δ}) is shown. The strontium content is hereby chosen only half as much as in the examples from the FIG. 3b. Also here a 2% substoichiometry. on the A-position results already in an improvement of the performance of more than 30%.

The increased electrochemical activity of the cathode according to invention due to an improved oxygen reduction behavior in comparison to the above-mentioned state of the art enables to operate SOFC fuel cells at relatively low temperatures of 750° C. or lower and still to achieve high performance densities especially above 1 W/cm² at 0.7 V. To be able to compare the performance capability of different cathode materials these should be tested under identical conditions, especially under conditions that correspond to the use in fuel cell staples. Hereto are accounted for example the minimum size of a cell that should not fall below 40×40 mm². Further a gas streaming should be provided parallel to the electrode surfaces. It is also important to provide the performance measurement at a certain cell voltage. Thereto especially a cell voltage of 0.7 Volt is suitable. Measuring conditions deteriorating therefrom can partially result in higher performance densities [4], [5]. These measuring conditions however are generally not relevant to use. Mechanical tensions lead in a smaller electrode surface less easier to failure while a perpendicular streaming that can not be realized in the fuel cell staple regularly leads to a higher gas exchange and therewith to higher performance densities. Moreover the cells described there can not be operated disadvantageously at a cell voltage of less than 0.7 V permanently since otherwise the risk exists that the nickel of the anode is oxidized.

Cited literature in the application:

[1] G. Stochniol, E. Syskakis, A. Nauomidis; J. Am. Ceram. Soc, 78 (1995) 929-932.

[2] S. P. Simmer, J. F. Bonnett, N. L. Canfield, K. D. Meinhardt, J. P. Shelton, V. L. Sprenkle, J. W. Stevenson; Journal of Power Sources 4965 (2002) 1-10.

[3] C. Christianse, S. Kristensen, H. Holm-Larsen, P. H. Larsen, M. Mogensen, P. V. Hendriksen, S. Linderoth in: SOFC-VIII (eds. S. C. Singhal, M. Dokiya) PV 2003-07, p. 105-112, The Electrochemical Society Proceedings, Pennington, N.J. (2003).

[4] J. W. Kim, A. V. Virkar, K. -Z. Fung, K. Metha, S. C. Singhal; J. Electrochimem. Soc., 146 (1999) 69-78.

[5] S. de Souza, S. J. Visco, L. C. De Jonghe; J. Electrochem. Soc., 144 (1997) L35-L37.

1. Cathode for high-temperature fuel cell comprising a cathode material with the chemical composition according to the formula Ln_{1-x-y}M_{y}Fe_{1-z}C_{z}O_{3-δ}
wherein
0.02≦x≦0.05,
0.1≦y≦0.6,
0.1≦z≦0.3,
0≦δ≦0.25
and wherein Ln=lanthanide, N=strontium or calcium and C=cobalt or copper,
wherein the cathode has an average grain size in the range of 0.4 to 1.0 μm.

2. The cathode according to claim 1 wherein 0.3≦y≦0.5, especially wherein y=0.4.

3. The cathode according to claim 1 wherein 0.15≦z≦0.25, especially wherein z=0.2.

4. The cathode according to claim 1 wherein Ln=lanthanum.

5. The cathode according to claim 1 wherein M=strontium.

6. The cathode according to claim 1 wherein C=cobalt.

7. The cathode according to claim 1 comprising La_{0.58}Sr_{0.4}Fe_{0.8}Co_{0.2}O_{3-δ}, La_{0.55}Sr_{0.4}Fe_{0.8}Co_{0.2}O_{3-δ}, La_{0.78}Sr_{0.2}Fe_{0.8}Co_{0.2}O_{3-δ} or La_{0.58}Sr_{0.4}Fe_{0.8}Cu_{0.2}O_{3-δ}.

8. The cathode according to claim 1, wherein the cathode has an average grain size in the range of 0.6 to 0.8 μm.

9. The cathode according to claim 1 wherein a porosity is equal to between 20and 40%, especially between 25 and 35%.

10. A method of preparing a cathode according to claim 1 comprising the steps of:
applying and sintering onto an anode-electrolyte composite a (Ce, Gd)O_{2-δ} powder with an average grain size of less than 0.8 μm such that a (Ce, Gd)O_{2-δ} intermediate layer results,
applying and sintering onto this intermediate layer a cathode material with the chemical composition according to the formula Ln₁₋ₓ₋₇M_{y}Fe_{1-z}C_{z}O_{3-δ} wherein
0.02≦x≦0.05,
0.1≦y≦0.6,
0.1≦z≦0.3,
0≦δ≦0.25
and wherein Ln=lanthanide, M=strontium or calcium and C=cobalt or copper as powder wherein an average grain size of less than 2 μm.

11. The method according to claim 10 wherein the cathode material is applied as powder with an average grain size between 0.6 and 0.8 μm.

12. Use of a cathode according to claim 1 in a fuel cell, wherein the cathode is arranged adjacent to a (Ce, Gd)O_{2-δ} intermediate layer wherein a porosity of less than 30%.
